(19) United States
(12) Patent Application Publication
(10) Pub. No.: US 2008/0192976 A1
(43) Pub. Date: Aug. 14, 2008

(54) MICRO SPEAKER AND ASSEMBLING METHOD FOR MICRO SPEAKER

(75) Inventor: HEUNG-BAE KIM, Bucheon City (KR)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: COTRON CORPORATION, Taipei City (TW)

(21) Appl. No.: 11/962,108

(22) Filed: Dec. 21, 2007

(30) Foreign Application Priority Data
Feb. 13, 2007 (KR) 1020070014888

(51) Int. Cl. H04R 1/00; B23P 11/00

(52) U.S. Cl. 381/412; 29/428

(57) ABSTRACT

A micro speaker including a housing, a ring, a vibration film, a coil, a magnet, a magnetism conductor and a circuit board is provided. The housing forms the shape of the micro speaker. The ring is disposed inside the housing. The vibration film is supported by the ring. The coil is disposed on the vibration film. The magnet is disposed on the ring. The magnetism conductor is disposed on the magnet. The circuit board is disposed on the magnetism conductor. The housing has an involuted portion on an edge of the housing near the circuit board or the ring, and the involuted portion is used to press against the circuit board or the ring. In this invention, the amount of glue used during the assembling of the components is minimized, and the output quality of the speaker is improved.

### CROSS-REFERENCE TO RELATED APPLICATION

This application claims the priority benefit of Korea application serial no. 10-2007-0014888, filed on Feb. 13, 2007. The entirety of the above-mentioned patent application is hereby incorporated by reference herein and made a part of this specification.

### BACKGROUND OF THE INVENTION

1. Field of the Invention

The present invention generally relates to a micro speaker and an assembling method for the micro speaker, capable of improving output frequency characteristics and tone quality characteristics of the micro speaker when minimizing volume.

2. Description of Related Art

Micro speakers are suitable for notebook computers, cameras, game machines, and desktop computers, but are particularly suitable for portable communication products. The notebook computer usually uses a speaker with a square structure, an input power of 10 mW, and a maximum input of 800 W. The speaker suitable for the portable communication product is increasingly minimized. Recently, many researches and developments on this aspect exist to satisfy the requirement.

FIG. 1 is a cross-sectional view of a micro speaker of the conventional art, and FIG. 2 is illustration of problems of the micro speaker of the conventional art. Referring to FIG. 1, the shape of a conventional speaker 100 is constituted by a front cover 160 and a housing 110, and a magnet 120 is disposed in the housing 110.

In detail, a lower part of the housing 110 is protruded, in which the magnet 120 is disposed. A flat panel 130 is disposed on the magnet 120. A printed circuit board 140 is disposed on the other side of the magnet 120, i.e., an outer side of the housing 110. A coil 180 is disposed in the housing 110 to form a magnetic field together with the magnet 120. A vibration film 170 for receiving electric signals to vibrate the air is also disposed in the speaker 100. Further, a fixing ring 150 for fixing the vibration film 170 is further disposed in the housing 110.

At the same time, several vent holes 111 and 161 are disposed in the housing 110 and the front cover 160 to perform air circulation between inside and outside of the speaker. In order to illustrate the problems of the conventional speaker 100, please refer to FIG. 2, in which the formation in the speaker 100 is shown.

Firstly, in order to fix the printed circuit board 140 outside the housing 110, a first fixing flue 190 is used to fix the printed circuit board 140 on the outer side of the housing 10.

Next, a second glue 191 is used to fix the magnet 120 inside the housing 110.

Third, a third glue 192 is used to fix the fixing ring 150 on the housing 110, and a fourth glue 193 is used to assemble the front cover 160 and the housing 110.

Fourth, a fifth glue 194 is used to assemble the vibration film 170 and the coil 180, and the sixth glue 195 is used to assemble the flat panel 130 and the magnet 120.

It can be known that most of the components of the conventional speaker 100 are assembled by glue. Particularly, the assembling of the vibration film 170 and the fixing ring 150, and the assembling other members and the housing 110 are all realized by glue. During drying process, the glues may shrink, such that spacing between the vibration film 170 and the coil 180 cannot be uniform, spacing between the vibration film 170 and the housing 110 cannot be uniform, and such nonuniformity affects the tone quality characteristics. The reason is that viscosity of the glue and the uniformity of the coating of the glue may affect the components that should keep slight spacing there between. Therefore, it is a distinctive disadvantage that the output frequency characteristics and the tone quality of the speaker cannot achieve good state.

### SUMMARY OF THE INVENTION

Accordingly, the present invention is directed to provide an assembling method for a micro speaker with preferred output tone quality by simplifying the assembling method for the micro speaker. At the same time, a micro speaker with preferred output quality and an assembling method for the micro speaker are provided by reducing the glue required to assemble the micro speaker as much as possible.

The micro speaker of the present invention includes a housing, a washer, a ring, a vibration film, a coil, a magnet, a magnetism conductor, and a circuit board. The housing forms shape of the micro speaker. The washer is accommodated in the housing. The ring is accommodated in the housing and located on the washer. The vibration film is supported by the ring. The coil is disposed on the vibration film. The magnet is disposed on the ring. The magnetism conductor is disposed on the magnet. The circuit board is disposed on the magnetism conductor. A guiding rib is disposed on inner wall of the housing, and a guiding notch corresponding to the guiding rib is respectively disposed at side edges of the magnet, the magnetism conductor, and the circuit board, so as to guide the assembling direction of the magnet, the magnetism conductor, and the circuit board.

The assembling method for the micro speaker of the present invention includes disposing a washer in a housing; disposing a ring, a vibration film, and a coil on the washer, in which the ring is disposed on the washer, the vibration film is disposed between the ring and the washer, and the coil is disposed on the vibration film; disposing a magnet on the ring; disposing a magnetism conductor on the magnet; disposing a circuit board on the magnetism conductor; and crimping an edge of the housing near the circuit board to form an involuted portion, so as to press against the circuit board.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a micro speaker of the conventional art.

FIG. 2 is an illustration of problems of the micro speaker of the conventional art.

FIG. 3 is a cross-sectional view of a part of the means of the micro speaker to be illustrated in the present invention.

FIG. 4 is an exploded view of the assembling method for the micro speaker of the present invention.

FIG. 5 is a simplified schematic view of the housing.

FIG. 6 is a simplified schematic view of the appearance of the micro speaker of the present invention.

FIGS. 7 and 8 are cross-sectional views of another two types of micro speakers of the present invention.

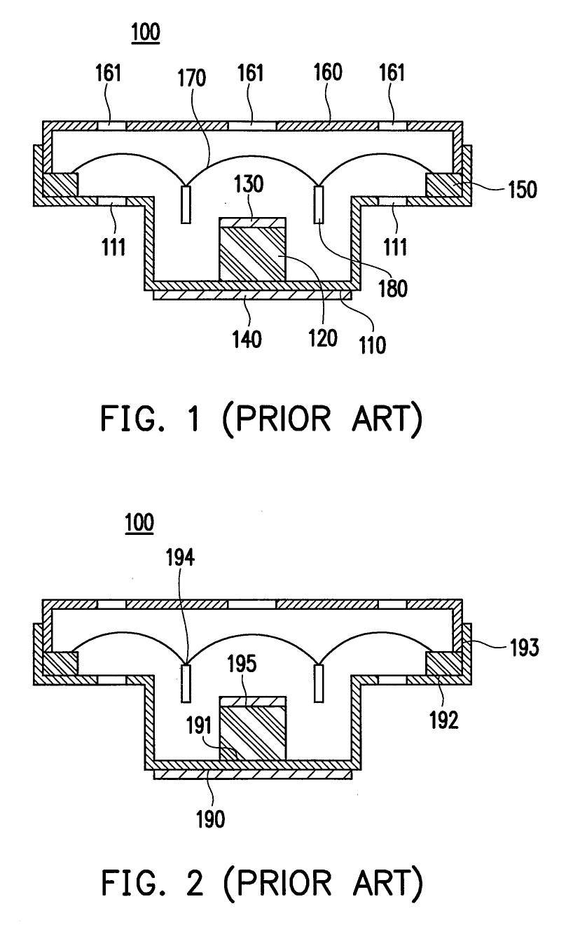

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

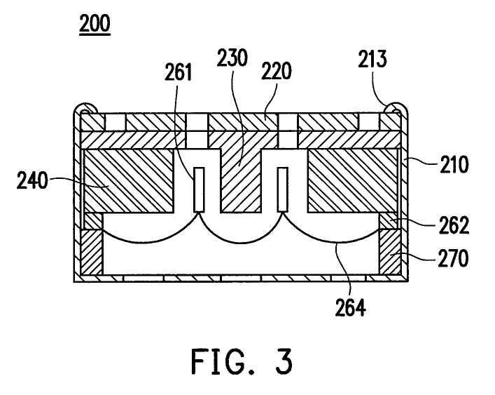

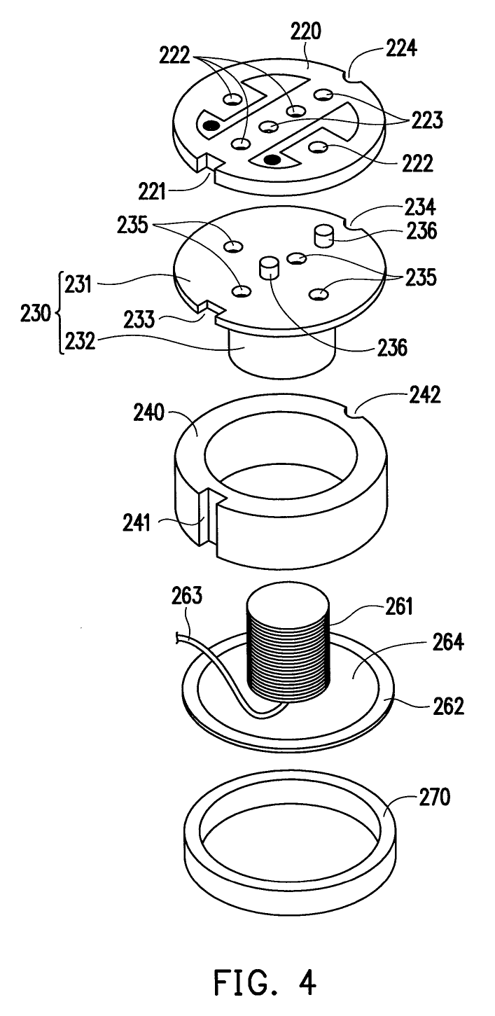

FIG. 3 is a cross-sectional view of a part of the means of the micro speaker to be illustrated in the present invention, and FIG. 4 is an exploded view of the assembling method for the micro speaker of the present invention.

Referring to FIGS. 3 and 4, it can be seen that a micro speaker 200 of this embodiment includes a housing 210 forming the shape, a washer 270 disposed in the housing 120, a ring 262 disposed on the washer 270, a magnet 240 disposed on the ring 262, a magnetism conductor 230 disposed on the magnet 240, and a circuit board 220 disposed on the magnetism conductor 230. Non-woven fabric or long fiber paper can be added between the magnetism conductor 230 and the circuit board 220. The ring 262 can be made of copper or other suitable materials. The magnetism conductor 230 can be made of iron or other suitable materials. The circuit board 220 can be a printed circuit board (PCB) or other forms of circuit boards.

In detail, an opening is formed on upper side of the housing 210 for the components to be disposed there from. The housing 210 can accommodate the washer 270, the ring 262, the magnet 240, and the circuit board 220. The housing 120 can be made of aluminum alloy or other suitable materials. After the housing 210 accommodates the components, an edge (i.e., the opening part) of the housing 210 near the circuit board 220 is crimped inside to form an involuted portion 213, and the circuit board 220 is pressed with a force provided by the involuted portion 213. The force provided by the involuted portion 213 can also be used to fix the washer 270, the ring 262, the magnet 240, and the circuit board 220 in the housing at the same time.

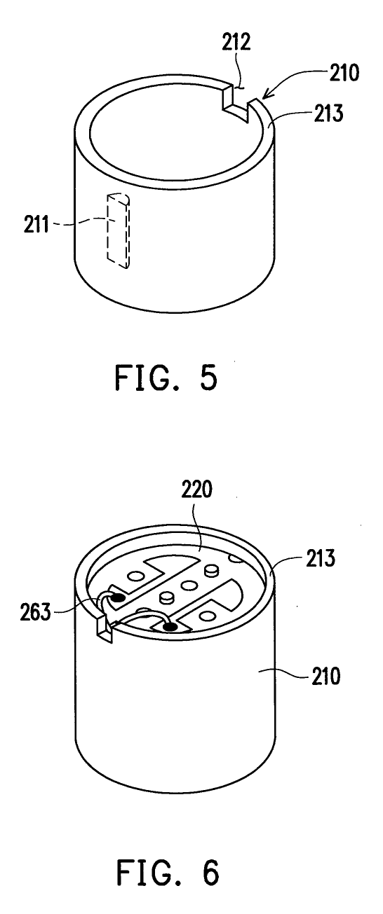

At the same time, in the micro speaker 200 of this embodiment, in order to fix the magnet 240, the magnetism conductor 230, and the circuit board 220 at correct positions, a guiding rib 211 is formed on inner wall of the housing 210, as shown in FIG. 5. The guiding rib 211 can be a protruded semi-cylindrical guiding column or of other forms. In order to match with the guiding rib 211, a guiding notch 242 is formed at the side edge of the magnet 240, a guiding notch 234 is formed at the side edge of the magnetism conductor 230, and a guiding notch 224 is also formed at the side edge of the circuit board 220. Therefore, the magnet 240, the magnetism conductor 230, and the circuit board 220 can be regularly assembled in the housing 210 along the guiding rib 211. The content of the technology can be known in detail in FIGS. 5 and 6.

In order to keep a certain distance between the ring 262 and bottom of the housing 210, a circular washer 270 is disposed before disposing the ring 262. Therefore, a certain distance is also kept between a vibration film 264 and inner bottom of the housing 210. Through this method, a resonance space is formed under the vibration film 264, such that the vibration film 264 may generate air vibration.

In order to form a magnetic field together with the magnet 240, a coil 261 is assembled on the vibration film 264, and an electrical wire 263 is connected thereon. Practically, the electrical wire 263 is two end parts of the coil 261, and is used to perform electrical conduction. However, the electrical wire 263 can be connected to the coil 261 through a jointing step, here similarly, it is considered as two end parts of the coil 261. It is necessary for the electrical wire 263 to connect to the circuit board 220 to finish the electrical conduction. A path through which the electrical wire 263 can pass is respectively disposed at side edges of the magnet 240, the magnetism conductor 230, and the circuit board 220. The path is formed by a line notch 221 at the side edge of the magnet 240, a line notch 233 at the side edge of the magnetism conductor 230, and a line notch 241 at the side edge of the circuit board 220. At the same time, the path has the function of fixing the electrical wire 263, such that the electrical wire can be securely electrically connected to the circuit board 220.

The magnet 240 vibrates by sensing the magnetic field formed by current of the coil 261, and the coil 261 and the vibration film 264 are pushed by interaction force generated according to Fleming's Left Hand Rule to generate sound. The magnetism conductor 230 on the magnet 240 has functions of restraining the magnetic field from leaking and enhancing intensity of the magnetic field. The magnetism conductor 230 is formed by an upper part 231 supporting the circuit board 220 and a lower part 232 capable of wrapping the coil 261. An accommodating space capable of accommodating the coil 261 exists in the lower part 232.

Particularly, in order to make the electrical wire 263 pass through, a line notch 233 is disposed at a side surface of the upper part 231, and a plurality of vent holes 235 is disposed on the upper surface for maintaining the air flow. A plurality of positioning bumps 236 is disposed on the upper surface of the upper part 231, for fixing the circuit board 220. At the same time, the circuit board 220 also has a plurality of vent holes 222 corresponding to the vent holes 235 of the magnetism conductor 230, and thus the outside air and the air in the housing 210 can finish the circulation through the vent holes 222 of the circuit board 220 and the vent holes 235 of the magnetism conductor 230.

In order to combine with the positioning bumps 236 of the magnetism conductor 230, the circuit board 220 further has a plurality of corresponding positioning holes 223. FIG. 4 shows that the circuit board 220 has several positioning holes 223 penetrating the circuit board 220. However, only several depressed points can also be formed on lower surface of the circuit board 220, but the depressed points do not penetrate the circuit board 220 for being combined with the positioning bumps 236, so as to finish the assembling of the magnetism conductor 230 and the circuit board 220.

In order to assemble the circuit board 220 along the guiding rib 211 on the inner wall of the housing 210, a guiding notch 224 is formed at one side of the circuit board 220, and the line notch 221 protecting the electrical wire 263 is formed on the other side. At the same time, the circuit board 220 further has the vent holds 222 formed for air flow and the positioning holes 223 formed for combination with the magnetism conductor 230. Through the line notches 221, 233, and 241, the exposed electrical wire 263 is welded on the surface circuit of the circuit board 220. The connection position of the electrical wire 263 and the circuit board 220 is determined by setting manner of electronic loop of the circuit board 220. The function of the circuit board 220 is the conventional art, so it is not described here.

Here, the washer 270, the vibration film 264, the coil 261, the magnet 240, the magnetism conductor 230, and the circuit board 220 are assembled in the housing 210, and after welding the electrical wire 263 formed by the ends of the coil 261 and the circuit board 220, the edge part of the housing 210 near the circuit board 220 is crimped inside to form the involuted portion 213, and the involuted portion 213 is used to closely press against the circuit board 220 to finish the assembling of the micro speaker 200 of this embodiment without glue. In FIG. 5, the position of the involuted portion 213 is merely simply marked and the involuted portion 213 is not drawn according to the practical state.

In order to make the step of crimping the housing 210 be easily performed, a notch portion 212 is formed at the edge of the housing 210 near the circuit board 220. In order to save the manufacturing cost, the length of the guiding rib 211 on inner side of the housing 210 can be determined according to sizes of the magnet 240, the magnetism conductor 230, and the circuit board 220.

FIG. 6 is a simplified schematic view of the appearance of the micro speaker of the present invention. The housing 210 and the upper surface of the circuit board 220 can be seen from FIG. 6. However, the position of the involuted portion 213 is merely simply remarked, but the involuted portion 213 is not drawn according to the practical state.

The electrical wire 263 jointed with the coil 261 in the housing 210 is welded on the circuit board 220 after passing through the line notch 221 of the circuit board 220.

FIG. 6 shows the state before crimping, and the totally finished assembly of the micro speaker 220 should be like FIG. 3. Through detailed illustration, it can be known that through the present invention, the assembling of each component of the micro speaker can be easily performed, and the assembling is finished without any glue, thus improving the quality.

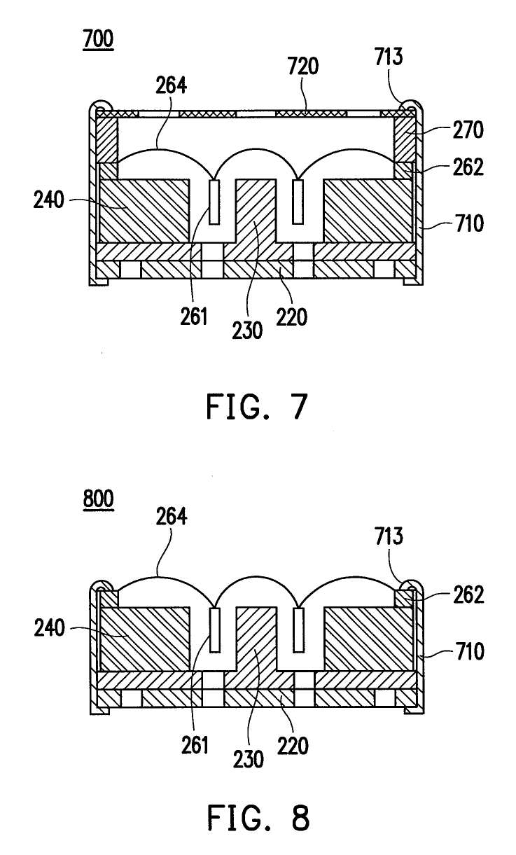

FIGS. 7 and 8 are cross-sectional views of another two types of micro speakers of the present invention. Referring to FIG. 7, a micro speaker 700 of this embodiment is similar to the micro speaker 200 of FIG. 3, and differences between the two are introduced as follows. A bottom of a housing 710 has an opening, but the bottom of the housing 710 is slightly bent to an L shape to carry other components. Placing sequence of each components in the housing 710 is opposite to that of the micro speaker 200 of FIG. 3, that is, the circuit board 220 is located on the bottom of the housing 710, and the washer 270is located on the topmost. At the same time, after the housing 710 accommodates each components, an edge of the housing 710 near the washer 270 is involuted to form an involuted portion 713, so as to press against the washer 270 with a force provided by the involuted portion 713. The force provided by the involuted portion 713 can also fix the washer 270, the ring 262, the magnet 240, and the circuit board 220 in the housing 710. In addition, a cover plate 720 is further disposed between the washer 270 and the involuted portion 713.

Next, referring to FIG. 8, differences between a micro speaker 800 of this embodiment and the micro speaker 700 of FIG. 7 lie in that the washer 270 and the cover plate 720 are omitted, and the involuted portion 713 of the housing 710 presses against the ring 262.

In the assembling method for the micro speaker of the present invention, a simplified operation manner can be used to produce the micro speaker with uniform and stable quality. Further, the using amount of the glue can be reduced to maintain and event to improve the stability of the output quality of the micro speaker.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A micro speaker, comprising:
a housing forming a shape;
a ring, accommodated in the housing;
a vibration film, supported by the ring;
a coil, disposed on the vibration film;
a magnet, disposed on the ring;
a magnetism conductor, disposed on the magnet; and
a circuit board, disposed on the magnetism conductor, wherein the housing has an involuted portion on an edge of the housing near the circuit board or the ring, and the involuted portion is used to press against the circuit board or the ring.

2. The micro speaker according to claim 1, wherein the housing has a guiding rib on an inner wall, and side edges of the magnet, the magnetism conductor, and the circuit board respectively have a guiding notch corresponding to the guiding rib.

3. The micro speaker according to claim 1, wherein the side edges of the magnet, the magnetism conductor, and the circuit board further respectively have a line notch, and two ends of the coil pass through the line notches to be electrically connected to the circuit board.

4. The micro speaker according to claim 3, wherein after the magnet, the magnetism conductor, and the circuit board are positioned in the housing through the guiding rib, the line notches are connected to form a straight-line channel.

5. The micro speaker according to claim 1, wherein a plurality of positioning bumps is disposed on a surface of the magnetism conductor, and a plurality of positioning holes corresponding to the positioning bumps is disposed on the circuit board.

6. The micro speaker according to claim 1, wherein a plurality of vent holes is disposed on the magnetism conductor and the circuit board, for the air to flow.

7. The micro speaker according to claim 1, further comprising a non-woven fabric, disposed between the magnetism conductor and the circuit board.

8. The micro speaker according to claim 1, wherein a notch portion is disposed at the edge of the housing having the involuted portion, and the notch portion makes the involuted portion be a discontinuous annular shape.

9. The micro speaker according to claim 1, further comprising a washer accommodated in the housing, wherein the vibration film is located between the ring and the washer, and the involuted portion is used to press against the washer.

10. An assembling method for a micro speaker, comprising:
disposing a washer in a housing;
disposing a ring, a vibration film, and a coil on the washer, wherein the ring is disposed on the washer, the vibration film is disposed between the ring and the washer, and the coil is disposed on the vibration film;
disposing a magnet on the ring;
disposing a magnetism conductor on the magnet;
disposing a circuit board on the magnetism conductor; and
crimping an edge of the housing near the circuit board to form an involuted portion, so as to press against the circuit board.

11. The assembling method for a micro speaker according to claim 10, wherein a line notch is respectively disposed at side edges of the magnet, the magnetism conductor and the circuit board, and two ends of the coil pass through the line notches.

12. The assembling method for a micro speaker according to claim 11, further comprising welding the two ends of the coil passing through the line notches on the printed circuit board.
